(19) United States
(12) Patent Application Publication
(10) Pub. No.: US 2017/0157704 A1
(43) Pub. Date: Jun. 8, 2017

(54) DETERMINING A SCANNING SPEED OF A MANUFACTURING DEVICE FOR THE ADDITIVE PRODUCTION OF A COMPONENT

(71) Applicant: MTU Aero Engines AG, Munich (DE)

(72) Inventors: Alexander Ladewig, Bad Wiessee (DE); Georg Schlick, Munich (DE); Johannes Casper, Munich (DE); Laura Buerger, Dachau (DE); Katrin Friedberger, Odelzhausen (DE); Christian Liebl, Bockhorn (DE)

(21) Appl. No.: 15/362,215

(22) Filed: Nov. 28, 2016

(30) Foreign Application Priority Data
Dec. 3, 2015 (DE) 10 2015 224 130.0

(51) Int. Cl. B23K 26/03; B23K 26/342; B23K 26/082; G01P 3/68

(52) U.S. Cl. CPC B23K 26/032; G01P 3/68; B23K 26/342; B23K 26/082; B23K 2201/001

(57) ABSTRACT

The invention provides a method for determining a scanning speed of a high-energy beam of a manufacturing device for the additive production of a component, in particular a component of a turbomachine, comprising the steps of guiding of the high-energy beam, which is generated by a radiation source of the manufacturing device, over a surface; detection of the path, irradiated during a predetermined period of time with the high-energy beam, on the surface, by recording respective brightness values on the surface by a detection device during the predetermined period of time; calculation of the scanning speed as a function of the predetermined period of time and of the detected irradiated path by an analysis device. The invention further relates to a method for operating a manufacturing device and to a manufacturing device for the additive production of a component of a turbomachine.

### BACKGROUND OF THE INVENTION

The invention relates to a method for determining a scanning speed of a high-energy beam of a manufacturing device for the additive production of a component, in particular a component of a turbomachine. The invention further relates to a method for operating a manufacturing device for the additive production of a component in accordance with the present invention. In addition, the invention relates to a manufacturing device for the additive production of a component, in particular a component of a turbomachine.

In the article in “Science and Technology of Welding and Joining” of April 2004 titled “Review of laser welding monitoring” by Deyong You and Seiji Katayama, a review that describes which methods are suitable for the monitoring of laser joining processes is presented. In particular, a number of optical and thermal methods are described therein.

An optical method for determining a scanning speed of a high-energy beam of a manufacturing device for the production of a component is known from US 2011/0286478 A1. In the method presented there, a laser is modulated with a pulse generator such that a dashed line is drawn on a surface. In the process, the dashed line is drawn, for example, by local fusion of a powdered material in a powder bed by the laser beam. Once the line has been drawn, it is measured. Alternatively or additionally, the number of discontinuities and/or respective dashes fused in the powder bed can be counted. Depending on this measurement and/or this count and depending on the signal of the pulse generator, it is then possible to determine a scanning speed of the laser.

### SUMMARY OF THE INVENTION

An object of the present invention is to create a method for determining a scanning speed of a high-energy beam of a manufacturing device as well as a method for operating such a manufacturing device, by which an additive production method can be ensured especially well in a qualitative manner. Moreover, it is an object of the invention to create a manufacturing device for the additive production of a component that operates in an especially reliable manner.

These objects are achieved in accordance with a method for determining a scanning speed, by a method for operating a manufacturing device, and by a manufacturing device for the additive production of a component of the present invention. Advantageous embodiments with appropriate enhancements of the invention are discussed in detail below, in which advantageous embodiments of the respective methods and of the manufacturing device are to be regarded as advantageous embodiments of the respective other method as well as of the manufacturing device, and vice versa.

A first aspect of the invention relates to a method for determining a scanning speed of a high-energy beam of a manufacturing device for the additive production of a component. In the process, a high-energy beam, produced by a radiation source of the device, is guided over a surface. It is possible to do this, for example, by deflecting the high-energy beam by at least one deflection device of the manufacturing device. Alternatively or additionally, the radiation source itself, for example, can also be moved over the surface to guide the high-energy beam. The surface can be formed, for example, from a powdered, pasty, or fluid starting material, which is fused by the high-energy beam for the additive production of the component. The starting material can involve, for example, metals, metal alloys, ceramic, and/or plastics.

A path on the surface that is irradiated with the high-energy beam during a predetermined period of time is detected by recording respective brightness values of the surface during the predetermined period of time by a detection device. The scanning speed is then calculated as a function of the predetermined period of time and the detected irradiated path by an analysis device. The scanning speed corresponds in this case to a speed with which the high-energy beam is guided over the surface. The scanning speed can be calculated, for example, by dividing a length of the detected path by the predetermined period of time. The radiation source can be a laser or a laser diode, for example. The scanning speed may also be referred to as a scan speed.

The detection is controlled in the process so that, while the high-energy beam is moved along the surface or the path, respective brightness values of the surface are recorded for a defined window of time. It is possible in this way to determine the path. The speed can be calculated by way of the defined recording time. Therefore, it is no longer necessary, for example, to measure the path by using a measuring microscope. Moreover, no complicated control of the radiation source by a pulse generator is necessary. In the method, therefore, it is not provided that the radiation source is controlled in order to determine the scanning speed, but rather that the detection device is controlled. It is possible for this purpose, for example, to switch the detection device on and off by a pulse generator in order to maintain the predetermined period of time for the detection. Alternatively, it is also possible to open and close an aperture of the detection device. In the process, the detection device can be controlled more precisely and more rapidly in comparison to the radiation source. In this case, the detection device can be disposed at a constant distance from the surface in order to enable an especially simple determination of the irradiated path.

The scanning speed is an important manufacturing parameter in the additive production of a component. The scanning speed has a great influence on the resulting quality of the component. In particular, the scanning speed has to be known exactly in order to be able to maintain especially high manufacturing tolerances. Especially in the production of a component of a turbomachine, such as, for example, a rotating blade or a guide vane, a high manufacturing precision is very important in order to be able to produce a turbomachine having a high efficiency. At the same time, the scanning speed should also be known in order to be able to adjust the power of the radiation source to the scanning speed. In this way, a homogeneous component quality is also ensured. The described method is an especially favorable, rapid and effective method for determining the scanning speed in an additive manufacturing device. In this way, the component quality can be well ensured and/or improved. At the same time, it is possible by determining the scanning speed to increase understanding of the production process.

The scanning speed can be influenced in the process by environmental factors, for example. For example, the scanning speed can differ in magnitude at different ambient temperatures. The scanning speed can be, in particular, a maximum speed with which the high-energy beam can be guided over the surface. The scanning speed can also change due to signs of ageing in the manufacturing device. For example, the lubrication of gearing for rotation of a mirror of the deflection device can become contaminated or can stick, as a result of which the mirror is able to rotate only sluggishly and, for this reason, may rotate more slowly, if necessary.

In another advantageous embodiment of the method according to the invention for determining the scanning speed, it is provided that the irradiated path is determined on the basis of pixels exposed in the detection device during the predetermined period of time. In this case, the detection occurs continuously during the predetermined period of time. It is possible to do this, for example, by opening an aperture of the detection device during the entire predetermined period of time. As a result, respective pixels of a chip of the detection device are exposed corresponding to the irradiated path during the predetermined period of time. This is comparable to a photo of a traveling automobile, shot at night with a long exposure time. Owing to the movement of the automobile, a headlight of the automobile appears in the image as a long drawn-out line. In a similar way, a reflection of the high-energy beam from the surface or a local glowing of the surface due to the irradiation with the high-energy beam can likewise be recorded as a long drawn-out line. In consequence of this, it is no longer necessary to undertake a tedious analysis of respective individual images or of a video in order to determine the irradiated path during the predetermined period of time. It is likewise not necessary to adjust a starting point in time and an end point in time exactly to the deflection of the high-energy beam. Instead of this, it should merely be ensured that the predetermined period of time for the detection is exactly maintained in order to enable an especially precise determination of the scanning speed.

Suitable as a sensor in this process is, for example, a so-called CMOS sensor. Alternatively, it is also possible to employ a CCD chip as a sensor. In this case, the accuracy of determination of the scanning speed depends largely on the resolution of the detection device and on the accuracy with which the predetermined period of time for the detection is maintained. Moreover, it is advantageous when any detection noise, such as, for example, the noise due to scattered light recorded at the same time, is suppressed.

In another advantageous embodiment of the method according to the invention for determining the scanning speed of the high-energy beam, it is provided that the high-energy beam is guided in a straight line and/or in a curved line over the surface during the detection. In the case of a straight line, an especially simple and especially precise determination of the scanning speed is possible, because no calculation errors occur owing to any curves in the path that are not taken into consideration. At the same time, it is possible in this way for the deflection device to be actuated in an especially simple manner. As a result, there are also no effects due to an overlap of a number of deflection directions, which might influence the determination of the scanning speed. In the case of a curved line, on the other hand, the scanning speed can also be detected using a special actuation of the manufacturing device. When an inner volume of the component is being filled, the high-energy beam is usually guided in a straight line over the surface. Subsequently, the high-energy beam can then be guided over the contour of the component in the respective layer, that is, over an outer boundary of the volume, in order to improve the component quality. This special actuation of the manufacturing device or a different guiding of the high-energy beam over the surface can result in a different scanning speed for this special actuation. In the case of the special actuation, this scanning speed can also be determined in this way without any problem. In the process, the length of the detected path must be calculated in a more complicated manner in some circumstances in order to determine correctly a length of curved lines as well.

In another advantageous embodiment of the method according to the invention for determining the scanning speed of the high-energy beam, it is provided that, during the predetermined period of time, a plurality of irradiated paths on the surface are determined by the detection device, and the scanning speed is calculated as a function of the predetermined period of time and the detected plurality of irradiated paths by the analysis device. In this way, it is possible to detect an especially large irradiated path in its entirety, as a result of which errors that occur during the determination of a length of each individual path carry less weight in the determination of the scanning speed. Accordingly, the method can detect an averaged scanning speed over a number of paths in a single measurement. Such a procedure allows an especially robust determination of the scanning speed. At the same time, this enables the utilization of a detection device that requires a long recording time in comparison to the scanning speed for the recording of a photo. For example, in order to record only one path, a camera would have to be able to capture a photo in 1 ms or faster. Such a camera is expensive and, moreover, a photo shot with such a short exposure time is highly prone to error. If, on the other hand, a plurality of traces are recorded, it is possible to utilize, for example, a camera that captures the photo in 100 ms. Accordingly, the camera can be more economical and the determination of the scanning speed is less prone to error.

In another advantageous embodiment of the method according to the invention for determining the scanning speed of the high-energy beam, it is provided that the scanning speed is calculated by the analysis device as a function of a period of time that is required for switching the irradiation from a first path to a second path. In this way, it is possible to include the plurality of irradiated paths for determining the scanning speed, without the occurrence of errors due to switching of the irradiation from one path to another path. The plurality of irradiated paths can be produced, for example, by way of a single guide trace, with the generation of the high-energy beam being deactivated in subregions of this guide trace and, as a result, the surface not being irradiated. For example, a meandering deflection of the high-energy beam can be provided, with the high-energy beam being activated only in parallel subregions of this meandering deflection. As a result, a number of mutually parallel paths are then irradiated. In this case, the period of time that is necessary for a switching the irradiation from the first path to the second path corresponds to the duration of time for guiding the high-energy beam through a curve of the meandering trace. For example, in this region, a pivot direction of a mirror of a deflection device for deflecting the high-energy beam is reversed. The period of time for such switching of the deflection direction can be known or can be estimated precisely. The period of time for switching the deflection direction is also referred to as the reversal speed. Advantageously, in this case, the laser beam is guided over the surface for the second path in a direction that is opposite to that of the first path.

In another advantageous embodiment of the method according to the invention for determining the scanning speed of the high-energy beam, it is provided that the high-energy beam is guided, at least during detection, over a specific subregion of the surface that is not a subregion of the surface that is utilized for the additive production of the component. This subregion for determining the scanning speed may also be referred to as a test region. One subregion of the surface therefore serves as a working surface and another subregion as a test surface. The subregion of the surface that is utilized for the additive production of the component can be a so-called powder bed, for example. To this end, it is possible to provide an additional separate test region for determining the scanning speed. As a result of this separate test region, on the one hand, a maximum component size is not limited by a test path. Moreover, the test region can be designed such that it can be reused. It is possible for this, for example, to form the test region from a ceramic. In the case of a powder bed, for example, a new powder layer must be applied after each passage of the high-energy beam. This additional effort can be saved in the test region or for the test surface. At the same time, the test surface can also be designed such that it allows an especially simple and/or precise detection of the irradiated path and/or irradiated surface. To this end, the test surface, for example, can be composed of an especially low-reflection material. Especially in the case of long recording times for detecting the irradiated path and/or the plurality of irradiated paths, reflections can lead to noise in the image and hence to an erroneous determination of the scanning speed.

In another advantageous embodiment of the method according to the invention for determining the scanning speed of the high-energy beam, it is provided that the irradiated path and/or the plurality of irradiated paths is or are detected by the detection device in the visible and/or infrared spectral range. For example, light in the spectral range of 350 nm to 1100 nm can be detected. Detection in the visible spectral range is especially simple and can occur with especially low-cost sensors. For detection in the infrared spectral range, it is possible to exclude any interfering influences due to reflection and/or mirroring in an especially simple manner. Therefore, it is suitable, in particular, for the determination of an irradiated path that serves simultaneously for the production of the component. It is thereby possible to understand respective brightness values of the surface as respective temperature values or respective magnitudes of thermal radiation. In particular, in the case of detection in the near-infrared spectral range, it is not necessary to bring about any optical alteration of the test surface as a result of the high-energy beam, but instead only to bring about a local heating, for example. In particular, the irradiated path and/or the plurality of irradiated paths can be detected by so-called optical tomography. Optical tomography is an imaging method for displaying a surface temperature of individual layers for an additive production method.

A second aspect of the invention relates to a method for operating a manufacturing device for the additive production of a component, in particular a component of a turbomachine. In accordance with the invention, it is provided that, in the process, a scanning speed of a high-energy beam, which is generated by at least one radiation source of the manufacturing device and is guided over a surface, is determined by a method according to the first aspect of the invention. The features and advantages ensuing from the method for determining the scanning speed of the high-energy beam of the manufacturing device may be taken from the descriptions of the first aspect of the invention, with advantageous embodiments of the first aspect of the invention to be regarded as advantageous embodiments of the second aspect of the invention, and vice versa.

In another advantageous embodiment of the method according to the invention for the operation of the manufacturing device, it is provided that a control of the manufacturing device is calibrated as a function of the determined scanning speed. The calibration can be conducted by the analysis device.

It is also possible to check a calibration of the manufacturing device as a function of the determined scanning speed. Respective environmental influences on the scanning speed of the manufacturing device can be taken into account by the calibration. In particular, as a result of this, the ambient temperature has only an especially small influence or none at all on the component quality. Moreover, as a result of a calibration, it is possible to well maintain the respective manufacturing tolerances. In the process, it is not necessary to carry out respective test and calibration measurements with additional instruments. The manufacturing device can instead itself carry out a measurement for calibration. Therefore, no special measurements and/or laboratory investigations are necessary. In this way, a calibration can be carried out routinely and/or in a very cost-effective manner. Accordingly, the component quality can be especially well ensured during its manufacture.

In another advantageous embodiment of the method for operating the manufacturing device, it is provided that the component is manufactured at least in part by irradiation of its surface, with the scanning speed being detected at least in part during this production of the component. Accordingly, a process monitoring and/or control during manufacture are or is therefore possible. This is also referred to as online monitoring. The scanning speed can be monitored intermittently or continuously during production of the component. In this way, it is possible to ensure the component quality especially well. At the same time, the manufacturing device is not blocked for the production of components during the determination of the scanning speed. As a result of this, the effective service time of the manufacturing device is especially long.

In another advantageous embodiment of the method according to the invention for operating the manufacturing device, it is provided that the radiation source and/or a deflection device of the manufacturing device for the deflection of the high-energy beam are or is controlled as a function of the determined scanning speed. Thus, the determined scanning speed can be taken into account immediately by an actuation of the manufacturing device for increasing the component quality. In particular, it is also possible to take into account a correction of respective scattering parameters during production of the component owing to a varying scanning speed. For example, the additive production can lead to a temperature increase in the manufacturing device during production. This temperature change can have an influence on the scanning speed. This change can thus be taken into account immediately. In this way, it is possible to especially well maintain manufacturing tolerances.

A third aspect of the invention relates to a manufacturing device for the additive production of a component, in particular a component of a turbomachine, with a radiation source for the generation of a high-energy beam that can be guided over a surface, with at least one detection device for detecting the path, which is irradiated with the high-energy beam during a predetermined period of time, on the surface by recording respective brightness values of the surface during the predetermined period of time, and with at least one analysis device for calculating a scanning speed as a function of the predetermined period of time and of the detected irradiated path. The analysis device can be, for example, a control computer of the manufacturing device.

Therefore, the manufacturing device is designed for the purpose of carrying out a method for determining the scanning speed of the high-energy beam according to the first aspect of the invention. Furthermore, the manufacturing device is designed for the purpose of operating it in accordance with a method according to the second aspect of the invention. The features and advantages ensuing from the method according to the first aspect of the invention and according to the second aspect of the invention may be taken from the descriptions of the first and second aspects of the invention, with advantageous embodiments of the first aspect of the invention and of the second aspect of the invention to be regarded as advantageous embodiments of the third aspect of the invention, and vice versa.

In another advantageous embodiment of the manufacturing device according to the invention, it is provided that the manufacturing device is designed for the purpose of producing the component by a selective laser melting method. The selective laser melting method may also be referred to as selective laser melting or, abbreviated, as SLM. It is possible by the selective laser melting method to produce especially precise components with high manufacturing tolerances and complex geometries. In this case, it is especially advantageous for the component quality when the scanning speed can be determined simply and/or taken into account continuously. The component to be manufactured can be a component of a turbomachine.

A fourth aspect of the invention relates to a component for a turbomachine. In this case, the component is produced in an additive manufacturing method. A manufacturing device used for this purpose is operated in this case in accordance with a method according to the second aspect of the invention. The manufacturing device utilized for this can be, in this case, a manufacturing device according to the third aspect of the invention. The features and advantages ensuing from the method according to the second aspect of the invention and from the device according to the third aspect of the invention may be taken from the descriptions of the second aspect of the invention and of the third aspect of the invention, with advantageous embodiments of the second aspect of the invention and the third aspect of the invention to be regarded as advantageous embodiments of the fourth aspect of the invention, and vice versa.

### BRIEF DESCRIPTION OF THE DRAWING FIGURES

Further advantages, features, and details of the invention ensue from the following description of a preferred exemplary embodiment as well as on the basis of the drawings. The features and combinations of features mentioned in the description as well as the following features and combinations of features mentioned in the description of the figures and/or shown solely in the figures can be used not only in the respectively given combination, but also in other combinations or alone, without departing from the scope of the invention.

Herein:

FIG. 1 shows, in a schematic sectional view, a manufacturing device for the additive production of a component; and

FIG. 2 shows, in a schematic plan view, a subregion of a surface on which a high-energy beam is irradiated using the manufacturing device according to FIG. 1.

### DESCRIPTION OF THE INVENTION

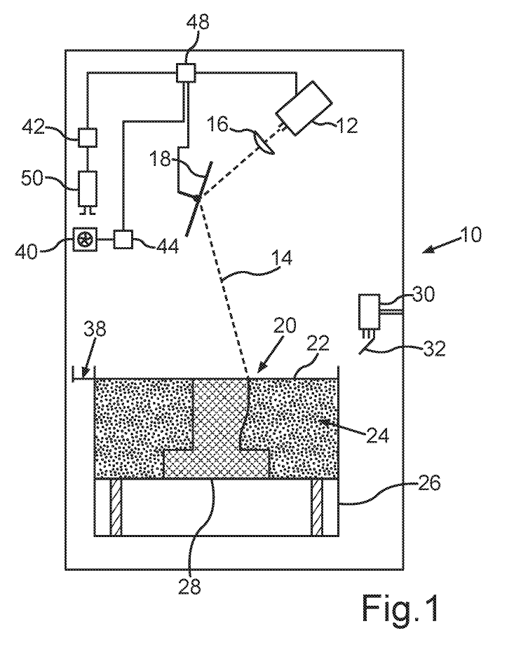

FIG. 1 shows, in a schematic sectional view, a manufacturing device 10 for the additive production of a component, in particular a component of a turbomachine. In this case, the manufacturing device 10 comprises a radiation source 12, which is designed as a laser diode, for example. By the radiation source 12, a high-energy beam 14, which is formed as a laser beam, is emitted. This high-energy beam 14 is bundled by a focusing device 16. Furthermore, the high-energy beam 14 is guided over a surface 20 by a deflection device 18. To this end, the deflection device 18 comprises, for example, a mirror mounted pivotably around two axes. However, the deflection device 18 can also comprise two mirrors that can pivot around one axis. Alternatively, it is possible, for example, for the radiation source 12 itself to move in a rotational and/or translational manner in order to guide the high-energy beam 14 over the surface 20. In this case, the surface 20 is formed by the uppermost powder layer 22 of a powder bed 24, which is applied on a variable-height construction platform 26. The powder can be formed, for example, from a metal, a metal alloy, a ceramic, and/or a plastic. A mixture of various powders made of different materials is also possible.

By the manufacturing device 10, a component can be produced by a so-called selective laser melting process. The uppermost powder layer 22 on the surface 20 is fused in a regional manner by the high-energy beam 14 for production of the component. In this way, it is possible, for example, to produce the complex geometry of a rotating blade of a turbomachine. In FIG. 1, a part 28 of this rotating blade or guide vane has already been completed in the powder bed 24. In this case, the component is constructed layer by layer. Once the construction of a layer has been finished, a new powder layer is applied to the construction platform 26 by the powder distribution device 30. This powder layer is smoothed by a doctor blade 32.

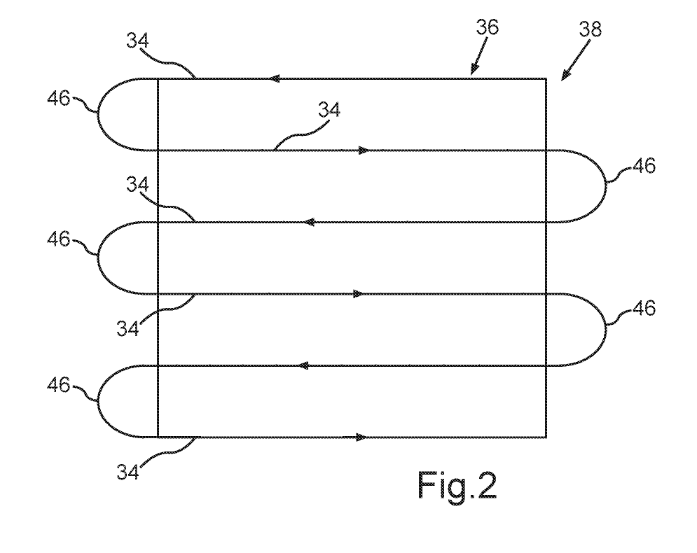

In order to be able to ensure an especially high component quality and to be able to maintain high manufacturing tolerances in the production, a scanning speed by which the high-energy beam 14 is guided over the surface 20 should be known. In this case, the scanning speed corresponds essentially to the speed with which the high-energy beam 14 is guided over the surface 20. In the example shown, the scanning speed corresponds to a speed with which the high-energy beam 14 can be deflected or is deflected by the deflection device 18. For determination of the scanning speed, the manufacturing device 10 comprises a detection device 50, by which a path 34, which is irradiated with the high-energy beam 14, and/or a plurality of irradiated paths 36 can be detected for a predetermined period of time. In this case, the irradiated path 34 and/or the plurality of irradiated paths 36 is or are shown in the schematic plan view of a subregion 38 of the surface 20 in FIG. 2.

In this case, the irradiated path 34 and/or the plurality of irradiated paths 36 is or are detected by recording respective brightness values of the surface 20 during the predetermined period of time. To this end, for example, a shutter 40, which is arranged between the detection device 50 and the surface 20, is opened only during the predetermined period of time. In this case, the opening of the shutter 40 can be controlled by a pulse generator 44 so as to be open only for a predetermined period of time in each case. As a result, it is not necessary to synchronize the radiation source 12 with the detection device 50. Likewise, it is not necessary to switch the radiation source 12 on and off by using, for example, a pulse generator. In the detection device 50, respective pixels, which correspond to the paths 34 according to FIG. 2, are exposed on a sensor chip during the predetermined period of time. These exposed pixels can be counted in a simple manner by an analysis device 42, for example. In the process, a minimum brightness value, which must be exceeded during the exposure, can be taken into account. For a known focal distance and a known distance of the detection device 50 from the surface 20, it is possible to calculate directly from the number of exposed pixels a length of the irradiated path 34 and/or a total length of the plurality of irradiated paths 36. The scanning speed is then obtained directly from the irradiated path 34 and/or from the plurality of irradiated paths 36 and the predetermined period of time.

The plurality of irradiated paths 36 is produced by a single guide trace, with the generation of the high-energy beam being deactivated in curved subsections 46 of this guide trace and, accordingly, the surface 20 not being irradiated. The guide trace corresponds to a meandering deflection of the high-energy beam by the deflection device 18. In this way, a plurality of mutually parallel paths 34 are then irradiated. In this case, the period of time that is required for switching the irradiation from one path 34 to another path 34 corresponds to the period for guiding the high-energy beam through the subsection 46 of the meandering trace. In this region of the guide trace illustrated in FIG. 2, a pivot direction of a mirror of the deflection device 18 for deflection of the high-energy beam is reversed. The period of time for such switching of the deflection direction can be known or can be estimated precisely. The period of time for switching the deflection direction is also referred to as the reversal speed. If the reversal speed of the deflection device 18 is known, it is further possible to calculate backwards to a total speed during the production of the component, even when the plurality of paths 36 are detected jointly. In this way, the precision of the determination of the scanning speed can be increased, because errors in the determination of a length of a single irradiated path 34 carry less weight. The detection of the plurality of irradiated paths 36 thus corresponds essentially to the detection of a single irradiated path 34 with a length that corresponds to the total length of the plurality of irradiated paths 36. Through the detection of the plurality of irradiated paths 36, it is possible, in addition, to provide for a longer exposure time for the detection device 50. As a result of this, a less expensive camera can be used, for example.

During the detection for determining the scanning speed, the high-energy beam 14 is guided over the subregion 38 of the surface 20 that is not a subregion of the surface 20 utilized for the additive production of the component. The subregion 38 of the surface 20 is thus a special test region for detecting the scanning speed. In this case, the subregion 38, for example, can be composed of a material that is not fused by the high-energy beam 14. The subregion 38 of the surface 20 can be formed by a ceramic, for example. In this way, the surface 20 in the subregion 38, which is also referred to as the test region, can be reused for determining the scanning speed. The surface 20 can be especially dull in this subregion 38 in order to reduce errors due to reflection. Through the determination of the scanning speed in the subregion 38, no unnecessary powder material is fused together and would then need to be disposed of or reprocessed. As a result, the manufacturing device 10 works especially efficiently. At the same time, the size of the subregion of the surface 20 that serves for production of the component is not limited by respective paths irradiated for determining the scanning speed.

Alternatively or additionally, however, the high-energy beam 14 can also be detected during production of the component. In this case, the high-energy beam 14 need no longer be deflected into a separate subregion 38 of the surface 20. The separate subregion 38 of the surface 20 can additionally be provided, however, in order to verify respective measurements of the scanning speed during the production of the component.

A control of the manufacturing device 10 can be calibrated as a function of the determined scanning speed. The scanning speed or the deflection speed of the deflection device 18 can be altered by signs of ageing and/or external influences, such as, for example, a change in temperature. This can result in deviations during the production of the component. These deviations are minimized or completely prevented by routine calibration.

Alternatively or additionally, the deflection device 18 can also be controlled as a function of the determined scanning speed during the production of the component, with the scanning speed then being detected continuously or intermittently during the production. In this way, it is possible to implement a control that also takes into account any deviations of the scanning speed during the production process. It is likewise possible also to control the power of the radiation source 12 as a function of the determined scanning speed. Depending on the speed of the high-energy beam 14 on the surface 20, different amounts of energy per unit area are introduced into the uppermost powder layer 22. If the maximum scanning speed has been reduced through external influences, for example, it may also be appropriate for this reason to correspondingly reduce the power of the radiation source 12. For the above-mentioned purposes, the manufacturing device 10 can comprise a control device 48, which is connected to the analysis device 42, the shutter 40 of the deflection device 18, and the radiation source 12 for the control thereof.

The detection device 50 can comprise, for example, a sensor for detecting the irradiated path 34 and/or the irradiated area 36, said sensor operating in the visible and/or infrared spectral range. Alternatively or additionally, respective filters can be provided in the detection device 50, these filters transmitting only light in a certain spectral range to a sensor. For example, the detection device 50 can be designed as a so-called optical tomograph. Detection in the optical spectral range is especially cost-effective and simple. Detection in the infrared spectral range can be especially exact, because interfering effects due to reflections and/or other light sources cannot occur. Preferably, in this case, a spectral range in the near infrared spectral range is detected, by which heat radiation from bodies markedly above the usual ambient temperatures can be detected. In particular, such a thermal detection is especially suited when the subregion 38 of the surface 20 is only heated by the irradiation with the high-energy beam 14 and is otherwise unaltered.

In the case of the manufacturing device 10, it is possible to determine a scanning speed of the high-energy beam 14 in an advantageous, rapid, and effective manner. As a result, an improvement and/or an assurance of the component quality is possible during production. Moreover, an understanding of the process of the additive production method can be thereby increased. Savings are possible, because no complicated test and/or calibration measurements are required any longer for determining the scanning speed. Instead of this, a continuous process monitoring can be implemented.

What is claimed is:

1. A method for determining a scanning speed of a high-energy beam (14) of a manufacturing device (10) for the additive production of a component of a turbomachine, comprising the steps of:
guiding of the high-energy beam (14), which is generated by a radiation source (12) of the manufacturing device (10), over a surface (20);
detection of a path (34), irradiated during a predetermined period of time with the high-energy beam (14), on the surface (20), by recording respective brightness values on the surface (20) by a detection device (50) during the predetermined period of time; and
calculation of the scanning speed as a function of the predetermined period of time and of the detected irradiated path (34) by an analysis device (42).

2. The method according to claim 1, wherein the irradiated path (36) is determined on the basis of pixels exposed by the detection device (50) during the predetermined period of time.

3. The method according to claim 1, during the detection, the high-energy beam (14) is guided in a straight line and/or in a curved line over the surface (20).

4. The method according to claim 1, wherein, during the predetermined period of time, a plurality of irradiated paths (36) are detected on the surface (20) by the detection device (50), and the scanning speed is calculated as a function of the predetermined period of time and the detected plurality of irradiated paths (36) by the analysis device (42).

5. The method according to claim 4, wherein the scanning speed is calculated by the analysis device (42) as a function of a period of time that is required for switching the irradiation of a first path (34) to a second path (34).

6. The method according to claim 1, wherein at least during the detection, the high-energy beam (14) is guided over a certain subregion (38) of the surface (20), which is not a subregion of the surface (20) that is utilized for the additive production of the component.

7. The method according to claim 1, wherein the irradiated path (34) and/or the plurality of irradiated paths (36) are detected by the detection device (50) in the visible and/or infrared spectral range.

8. The method according to claim 1, wherein a manufacturing device (10) is operated for the additive production of a component of a turbomachine and wherein a scanning speed of a high-energy beam (14), generated by at least one radiation source (12) of the manufacturing device (10) and guided over a surface (20).

9. The method according to claim 8, wherein a control of the manufacturing device (10) is calibrated as a function of the determined scanning speed.

10. The method according to claim 8, wherein by irradiation of the surface (20), the component is produced at least in part, with the scanning speed being detected at least in part during this production of the component.

11. The method according to claim 10, wherein the radiation source (12) and/or a deflection device (18) of the manufacturing device (10) for deflection of the high-energy beam (14) are controlled as a function of the determined scanning speed.

12. A manufacturing device (10) for the additive production of a component of a turbomachine, comprising:
at least one radiation source (12) for the generation of a high-energy beam (14), which can be guided over a surface (20);
at least one detection device (50) for the detection of the path (34), which is irradiated with the high-energy beam (14) during a predetermined period of time, on the surface (20), by recording respective brightness values of the surface (20) during the predetermined period of time; and
at least one analysis device (42) for the calculation of a scanning speed as a function of the predetermined period of time and of the detected irradiated path (34).

13. The manufacturing device (10) according to claim 12, wherein the manufacturing device (10) produces the component by a selective laser melting method.
